(19) United States
(12) Patent Application Publication
(10) Pub. No.: US 2003/0011613 A1
(43) Pub. Date: Jan. 16, 2003

(54) Method and apparatus for wide gamut multicolor display

(76) Inventor: Lawrence A. Booth JR., Phoenix, AZ (US)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 09/906,634

(22) Filed: Jul. 16, 2001

(51) Int. Cl. G09G 5/02

(52) U.S. Cl. 345/589

(57) ABSTRACT

Numerous embodiments of a method and apparatus for a wide gamut color display are disclosed.

### BACKGROUND

1. Field

This disclosure relates to electronic multicolor displays.

2. Background Information

State of the art displays, such as computing systems displays, for example, typically employ a grouping of three-color pixels to display the range of available colors. Red-Green-Blue (RGB) is the standard 3 primary color set comprising the sub pixels in the existing display technology, wherein the display technology may be, for example, LCD (liquid crystal display), CRT (cathode ray tube), polymer display, or other types of display technologies. The RGB methodology is limited in some respects, as it can represent only a portion of the color gamut capable of being perceived by humans, has limited color-matching abilities, and also may not have particularly high luminous efficiency.

Improving these aspects of a display is desirable for a variety of reasons. Color matching is becoming continually more desirable as printing and photo editing are become more commonplace, and a desire to have colors reproduced consistently on a display and from a printer exists in the marketplace. Efficiency is becoming more desirable as well, as extending battery life and increasing energy savings are increasing in desirability in the industry. Display technologies that address some or all of these issues are, therefore, being sought.

### BRIEF DESCRIPTION OF THE DRAWINGS

Subject matter is particularly pointed out and distinctly claimed in the concluding portion of the specification. The claimed subject matter, however, both as to organization and method of operation, together with objects, features, and advantages thereof, may best be understood by reference to the following detailed description when read with the accompanying drawings in which:

FIG. 1 is a schematic diagram of an LCD based display in accordance with one embodiment of the claimed subject matter.

FIG. 2 is a color conversion flowchart in accordance with one embodiment of the claimed subject matter.

FIG. 3 is a chromaticity diagram showing the color gamut achieved with a standard three-color display and showing a color gamut that may be achieved with an embodiment of a wide gamut display.

FIG. 4 is a schematic diagram illustrating a pixel layout in accordance with one embodiment of a wide gamut display.

### DETAILED DESCRIPTION

In the following detailed description, numerous specific details are set forth in order to provide a thorough understanding of the claimed subject matter. However, it will be understood by those skilled in the art that the claimed subject matter may be practiced without these specific details. In other instances, well-known methods, procedures, and components have not been described in detail so as not to obscure the claimed subject matter.

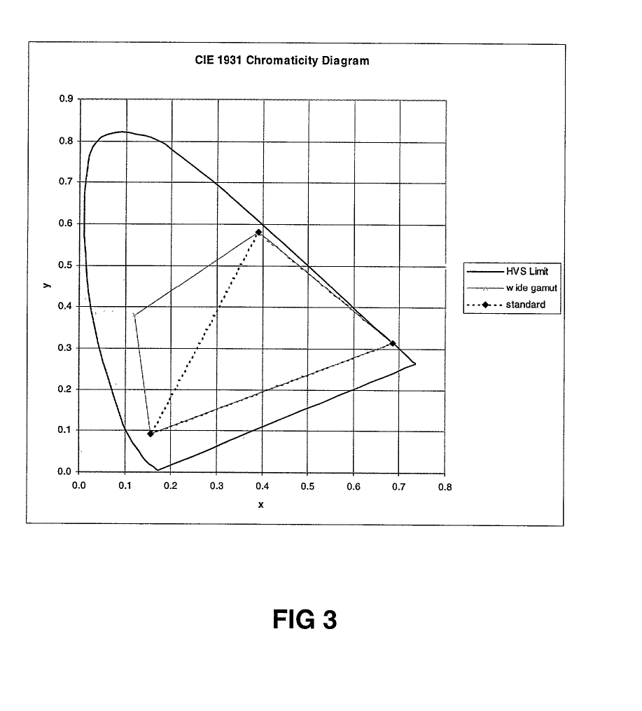

As previously indicated, it is desirable for a number of reasons to have a color display capable of displaying an extended range of color as compared to existing technology. In this context, a range of color refers to the gamut of colors that can be displayed on an electronic multicolor display that incorporates no more than three primary colors in order to reproduce an image. An extended range of color refers to a gamut of colors that is more than the gamut of a three primary color based electronic multicolor display, as measured on a chromaticity diagram, for example. Current state of the art color displays utilize pixels or elements containing sub pixels, which themselves consist of the three primary colors of red, green and blue (RGB), which define the available color space, or gamut. State of the art displays typically produce digital images by incorporating an array of picture elements, or pixels, and, in this context, a pixel comprises one or more sub elements or sub pixels, where the sub elements or sub pixels comprise materials capable of displaying one or more primary colors. In one such embodiment these colors comprise red, green and blue. The RGB range of colors creates a limit for what colors can be displayed on an electronic multicolor display, and there is a portion of the human visible spectrum (HVS) that cannot be represented on an electronic multicolor display incorporating pixels that have only these three primary colors. In this context, the term “human visible spectrum” refers to the spectrum of colors that is typically viewable or perceivable by humans. Additionally, developments in printing technology have created a multiplicity of inks that exceed the ability of an electronic multicolor display to represent, with good fidelity, what the printed product will look like to humans. To illustrate these concepts more concretely, FIG. 3 is a plot of the 1976 Commission Internationale de l'Eclairage (CIE) color space on a chromaticity diagram, which is a two-dimensional diagram that represents human color sensitivity. The gamut achieved with a standard three primary color display is represented by the triangle traced by the dotted line in FIG. 3, and the extended gamut, which an embodiment of a wide gamut display may provide, as described in more detail hereinafter, is at least partially represented by the inner solid line.

Luminous efficiency has become increasingly desirable in computing and other industries, as it relates to power efficiency, and battery life, such as for a given computer system, for example. Incorporating four primary colors in an electronic multicolor display may allow for greater power efficiency. As an example, cyan has a dominant wavelength of approximately 480 nanometers (nm), while a deep blue has a dominant wavelength of approximately 440 nm. As is well-known, the standard human observer luminous efficiency for 480 nm is 0.1390, and for 440 nm, the luminous efficiency is 0.0230. In a four primary color display, therefore, cyan may be employed to contribute to the display of white, which may result in approximately 5 times greater efficiency than using a deep blue, primarily because less power is employed to produce the display of white when employing cyan rather than when employing deep blue. This is just one example of potential efficiency that may be provided by an embodiment of a wide gamut display, and it will, of course, be understood that the claimed subject matter is not limited in this respect.

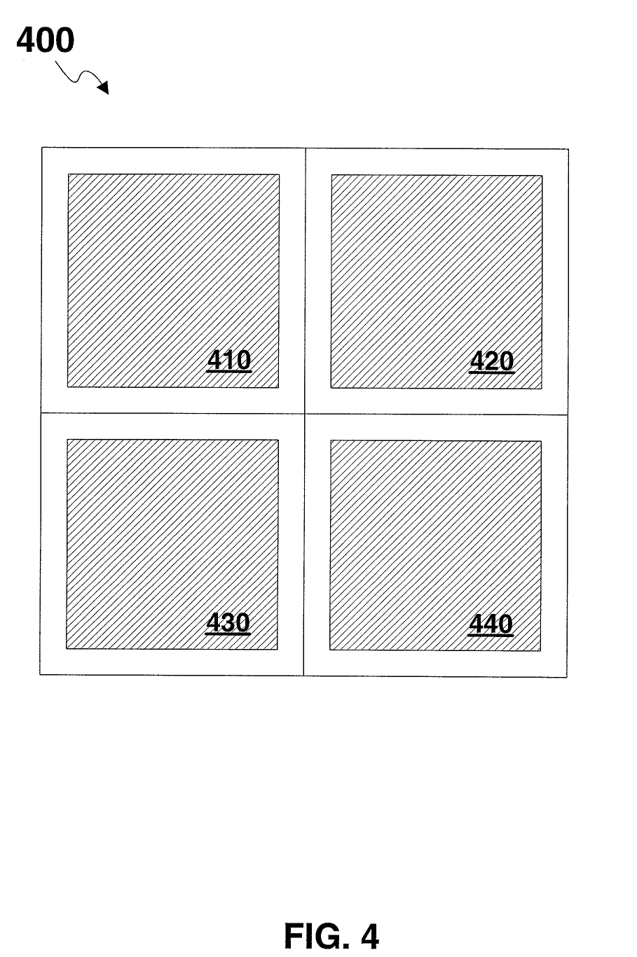

In accordance with one embodiment, although the claimed subject matter is not limited in this respect, an apparatus comprising an electronic multicolor display may be a display that is of a type typically used as a peripheral device for a computer system, which, in one embodiment, may be referred to as a monitor. Electronic multicolor displays, or monitors, in this example, are frequently pixel based, and one skilled in the art would understand that pixel based refers to the elements of a display that contain a particular number of sub pixels or sub elements, these elements typically being capable of displaying one or more primary colors. As stated previously, typically a pixel comprises three sub pixels, with the sub pixels having the capability to respectively display the colors of red, green, and blue. In one embodiment of a wide gamut multicolor display, however, a pixel in an electronic multicolor display may comprise four sub pixels or sub elements, where the sub pixels, for example, respectively, have the capability to display the following four colors: Red, Green, Blue and Cyan (RGBC). Again, this is just one sample embodiment and the claimed subject matter is not limited in scope to just this example. For example, sub pixels in accordance with the claimed subject matter may have the capability to display, alternatively, the primary colors Red, Green, Blue and Green (RGBG), as just one example. FIG. 4 is an illustration of a pixel in accordance with the present embodiment. In this particular embodiment, 410 represents a red sub pixel, 420 represents a green sub pixel, 430 represents a blue sub pixel, and 440 represents a cyan sub pixel, although it will be understood that this particular arrangement is just one embodiment, and the claimed subject matter is not limited to this embodiment. In at least one such device, at least a portion of the pixels may be temporarily excited by an electric charge, which may cause them to display a color visible to the human eye. Again, it will, of course, be understood that this is just one particular embodiment, and the claimed subject matter is not limited in this respect. For example, the claimed subject matter is not limited to just computer displays, but may additionally comprise television broadcast display devices, as just an example. Also, other techniques for displaying colors visible to the human eye may be employed. Furthermore, the subject matter is not limited to any particular color combination, as was explained previously, or to a particular shape or arrangement of sub pixels.

One embodiment may use light emitting polymer materials as an electro luminescent material, which as is well known, are materials that are typically coupled to one or more electrodes, and generate light when an electric charge is applied. These light emitting polymer materials may be used to produce a light emitting polymer display, which may also be referred to as an organic light emitting polymer display (OLED). In this embodiment, the electro luminescent material may be utilized for at least a portion of the pixels incorporated in an electronic multicolor display. However, it will be understood by one skilled in the art that there are a number of other ways in which to produce a multicolor display. For example, liquid crystal displays (LCD), cathode-ray tube displays (CRT), which incorporate phosphors as pixels and sub pixels, electro-luminescent or crystalline light emitting diodes (LED), or even small molecule light emitting diode-based displays, may be employed in embodiments of a multicolor wide gamut display within the scope of the claimed subject matter. In this particular embodiment, however, light emitting polymer material may be employed to produce elements or pixels that incorporate at least four sub-elements, such elements or sub pixels may respectively have the ability to display a different one of four primary colors. The four primary colors in this particular embodiment are red, blue, green, and cyan (RBGC), although it will be understood that other combinations of colors are possible in accordance with the claimed subject matter. In this embodiment, the pixels are capable of emitting a primary color or a combination thereof, depending on the technique employed to display a given image, such as, for example, how the particular display applies a charge to the various sub pixels in the display. It is well established that displays that incorporate light emitting polymer materials as electro luminescent materials are typically operated by injecting charge carriers from one or more contact layers into at least a portion of the light emitting polymers, and light is emitted when the charge carriers decay. Of course, it would be understood by one skilled in the art that the claimed subject matter is not limited in scope in this respect. Many of these displays, however, are well known in the art, as explained, for example, the following texts: Display Systems, Design and Applications, Edited by Lindsay W MacDonald and Anthony C Lowe, John Wiley and Sons, ISBN 0-471-75870-0, or Electronic Displays, Sol Sherr, John Wiley and Sons, ISBN 0-471-63616-9.

In accordance with one embodiment, a polymer display may be fabricated to include pixels capable of producing one or more four primary colors. The previously referenced texts provide, without limitation, examples of polymer displays. As is well-known, polymer displays typically incorporate at least one semiconductive polymer sandwiched between a pair of contact layers. These contact layers may be capable of producing an electric field, which injects charge carriers into the polymer layer. In one embodiment, as stated previously, when the charge carriers combine in the polymer layer, the charge carriers decay and may emit radiation in the visible light frequency range. In this particular embodiment, numerous semiconductive polymers may be incorporated to produce different primary colors, for example poly (p-phenylenevinylene) (PPV) may be used as a polymer material to emit green light, and poly(methylethylhexyloxy-p-phenylenevinylene) (MEH-PPV) may be employed to emit red-orange light. It will, of course, be understood that these are just examples, and the claimed subject matter is not limited to these examples.

In accordance with the present embodiment, polymer materials may be deposited on a substrate containing one or more electrodes by spin-coating, ink jet methods, lithography, or any number of other methods, all of which are well known within the art. In this particular embodiment, an ink jet technique may employ a glass substrate with alternating grooves or channels and wells. The grooves may form the sub pixel areas into which various polymers are deposited, and the wells may assist in the fabrication of various patterns of polymers.

In comparison to existing three color display fabrication methods, in this particular embodiment, the fabrication of a four color display may employ additional fabrication or processing, which may include one or more masks. In one particular embodiment, the additional processing may comprise an additional ink jet process, which may apply the fourth light emitting layer including a fourth sub pixel to a substrate. The four separate ink jet processes may each respectively deposit a separate light emitting polymer layer on at least a portion of the substrate. The additional processing may form the sub pixel for the additional, fourth primary color of the four color display. In a process where a mask is used in the fabrication of a display, typically three separate masks are used to deposit polymer layers of different primary colors on a substrate. In the present embodiment, however, a fourth mask may be utilized to deposit the fourth polymer layer on a substrate. In this context, a mask is a technique used primarily to allow deposition of material on particular areas of a substrate, while preventing deposition on other areas, depending on the physical features of the mask. It will be understood that additional processing or an additional mask is just one possible embodiment, and the claimed subject matter is not limited in this respect.

In another embodiment, although the claimed subject matter is not limited in this respect, a polymer display may comprise an array of repeating sets of four spatially displaced light emitting polymers. In this particular embodiment, the light emitting polymers may be deposited on a substrate, for example, foil or glass, and active elements may be incorporated to selectively activate the polymers to emit light. In this embodiment, thin film transistor circuitry may be provided for the sub pixels of the four primary color pixels in such a display. It will, of course, be understood that the claimed subject matter is not limited to polymer displays, as stated previously.

In yet another embodiment, a four primary color display may comprise a liquid crystal display. A liquid crystal display, in this embodiment, may comprise a grouping of liquid crystal pixels or elements, which are formed from sub pixels or sub elements that are capable of displaying at least four primary colors. As is well-known, liquid crystal displays are non-emissive display devices, and the pixels themselves do not produce light but typically block light in order to display images. In this embodiment, the liquid crystal display may comprise at least two polarizers, at least two pieces of glass or other material to contain the liquid crystal material, and electrodes to control the rows and columns of pixels by applying or removing an electrical charge. In this embodiment, polarizers are used to polarize light so that the light properly interacts with one or more pixels. In this particular embodiment, a material such as Indium Tin Oxide (ITO) may be utilized to define the borders for a plurality of pixels, which may comprise at least four sub pixels. The ITO, in operation, for example, has a charge applied or removed to change the orientation of the associated liquid crystal structure, resulting in light passing through the crystals or light being blocked by the crystals. In one embodiment, a pixel has an associated thin film transistor, while in an alternative embodiment, a pixel has an associated diode that is capable of applying or removing a charge. The use of polarizers and electrodes in the fabrication of liquid crystal displays is well known in the art. It will, of course, be understood that this is just one embodiment, and the claimed subject matter is not limited in this respect.

In this particular embodiment, the liquid crystal display may be fabricated to produce a display that is capable of displaying an extended range of colors using well-known liquid crystal display fabrication processes but with additional processing to fabricate the at least four primary colors. As is well known, numerous fabrication methods exist to fabricate an LCD display. Typically, a grouping of thin film transistors or other devices capable of delivering an electric charge may be mated to one or more substrates. The one or more substrates may comprise glass or plastic or other materials, in one embodiment. The area between the substrates may then be filled with liquid crystal material in this embodiment, and, in this particular embodiment, the grouping of devices capable of producing an electric charge may comprise devices that are capable of producing an electric charge and applying it to at least four sub pixels in a pixel. In this embodiment, the display is illuminated by at least four light emitting diodes. The light emitting diodes may comprise the colors of red, green, blue and cyan, for example. It will, of course, be understood that this is just one particular embodiment, and does not limit the scope of the claimed subject matter.

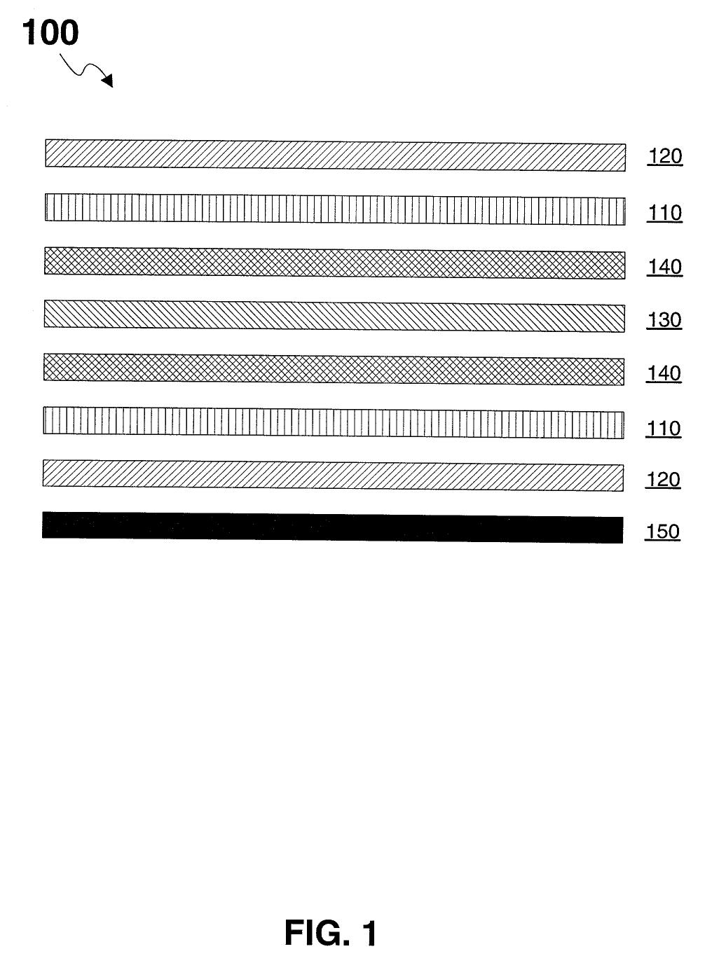

FIG. 1 is one possible embodiment of a liquid crystal display in accordance with the claimed subject matter. 100 comprises one particular type of LCD based display that is accordance with the claimed subject matter. 110 comprises a set of substrates that will receive the deposition of liquid crystals, and may comprise glass, plastic, or other material types. 120 comprises a set of polarizers, which, as stated previously, are used to polarize light so that the light properly interacts with one or more pixels. 130 represents the liquid crystals, which, in this embodiment, comprise pixels or elements, which are formed from sub pixels or sub elements that are capable of displaying at least four primary colors. The liquid crystals 130, in this embodiment, are sandwiched between a set of electrodes 140, which are themselves coupled to the substrates 110. The electrodes 140 may comprise such materials as Indium Tin Oxide to define the borders for a plurality of pixels 130, which may comprise at least four sub pixels. 140, in operation, for example, has a charge applied or removed to change the orientation of the associated liquid crystal structure 130, resulting in light passing through the crystals or light being blocked by the crystals. A light source 150 provides light to be passed through or blocked by the crystals 130. It will, of course, be understood that this is just one possible embodiment of the claimed subject matter.

Methods for converting from a three primary color space to a four primary color space is well known in the printing industry, specifically in regard to converting from RGB to CYMK, for example. The process of converting colors from one color space to another is referred to in this context as color conversion. As is well-known, colors in a given color space are substantially fixed in relation to the color space's white point, which may vary from device to device. A balancing technique may be employed to balance the colors appropriately around this white point. In this particular embodiment, converting an image from a three primary color space to a four primary color space for display on a four primary color display may include the following: determining the color coding for a given image, applying a technique to convert the coding to four primary colors, and then adapting or modifying the color coding for display on an electronic multicolor display, such as an embodiment of a multicolor wide gamut display. In this context, as previously described, a multicolor display may comprise pixels that are polymer based, LCD based, or CRT based, but, of course, the claimed subject matter is not limited in scope in this respect. In this context, coding refers to the data that is used to determine how much charge to apply to a given pixel or sub pixel in order to produce an image on an associated display. It will, of course, be understood that coding is not limited to just applying a charge, but may also refer to, for example, applying or removing charges from other elements that may affect a pixel or sub pixel.

The following conversion matrix equation provides a general technique to convert from a typical image color description to modified four-color intensities for a four color space, as previously described. This conversion matrix equation, in one embodiment, may be utilized by a computing platform coupled to a graphics controller to convert coding for a given image from one color space to another color space. The conversion may be implemented in hardware, firmware, software, or any combination thereof, but the claimed subject matter is not limited in this respect, or to the specific mathematical or algorithmatical form of the conversion.

$$[ \begin{matrix}{a}_{11} & {b}_{12} & {c}_{13} \\ {a}_{21} & {b}_{22} & {c}_{23} \\ {a}_{31} & {b}_{32} & {c}_{33} \\ {a}_{41} & {b}_{42} & {c}_{43}\end{matrix} ] \cdot [ \begin{matrix}R \\ G \\ B\end{matrix} ] = [ {R}^{′} {G}^{′} {C}^{′} {B}^{′} ] \qquad ( 1 )$$

where aₙₙ, bₙₙ, cₙₙ are display coefficients, R,G,B are the input image three color space intensities, and R′, G′, C′, B′ are the Red, Green, Cyan, and Blue intensities in four color space.

The specific values of the coefficients are generally determined by the type of display and are dependent at least in part on this and the design of display. These coefficients may be chosen to substantially maintain the pixel color being emitted or provided, while improving either luminance or power dissipation, and/or may also be modified to provide a hue or tint, depending, for example, on the display. In addition to conversion from typical RGB color space, a similar form may be used to convert from any three coordinate color space, such as the CIE standard X, Y, Z color stimulus space, for example. A software process or other process, for example, may be implemented as part of a graphics controller, in one possible embodiment, to convert a pixel and its associated sub pixels to display an image initially coded for a three color display to display in a four or more primary color display. It will, of course, be understood that this is just one possible conversion technique, and others may be employed.

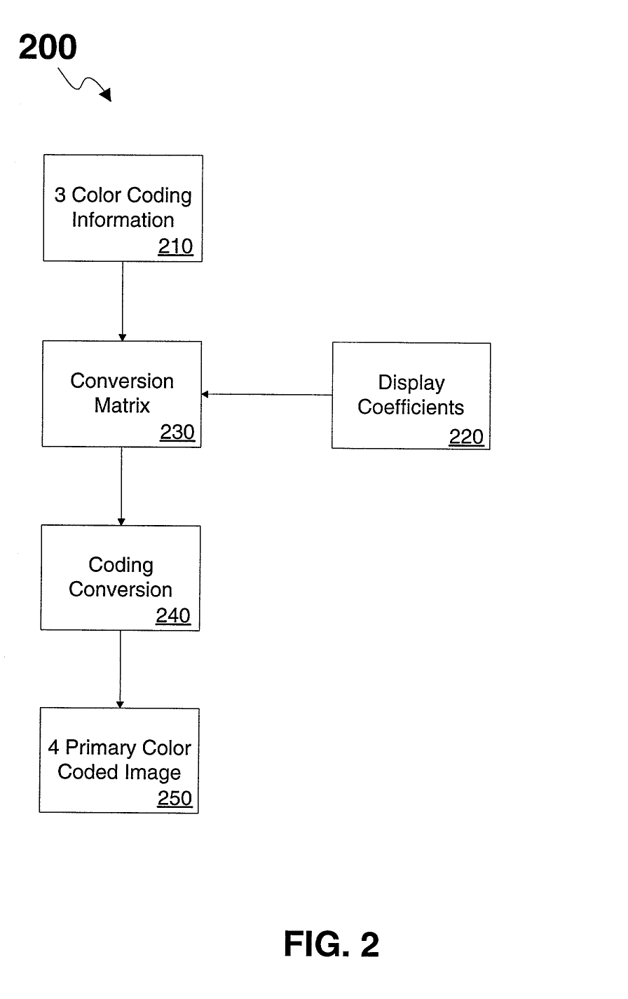

FIG. 2 is a flowchart demonstrating one possible method for converting an image from a 3 primary color space to a four primary color space. As stated previously, flowchart 200 may be used to convert images displayed on a multicolor display, which may comprise pixels that are polymer based, LCD based, or CRT based, but, of course, the claimed subject matter is not limited in scope in this respect. In flowchart 200, converting an image from 3 primary color space to four primary color space is to substantially determine the color coding for an associated image displayed in three primary color space. As stated previously, color coding refers to the data that is used to determine how much charge to apply to a given pixel or sub pixel in order to produce an image on an associated display, in one embodiment. The color coding 210 is supplied to a conversion matrix 230, which may be a conversion matrix such as equation 1 above. As stated previously, this conversion matrix may be implemented in hardware, firmware, software, or any combination thereof, but the claimed subject matter is not limited to any particular type of implementation. The conversion matrix 230 also receives information about the display coefficients, represented by 220. As stated previously, the display coefficients are generally determined by the type of display and are dependent at least in part on this and the design of display. After the conversion matrix substantially receives the relevant information, the conversion is performed in 240, and the resultant information is used to display an image in four primary color space, represented by 250. It will, of course, be understood that this is just one particular embodiment of the claimed subject matter, and several other methods for image conversion are possible, and in accordance with the claimed subject matter.

As is well-known, numerous techniques may be utilized to convert images displayed in three primary color space for printing on four color printers. Many of these techniques may be adapted for the purposes of converting an image displayed in three primary color space for display in at least four primary color space. In one such technique, gamut mapping is used to convert a given color to the color most similar in a different color spectrum. Gamut mapping typically is a method where a ‘source’ gamut is mapped on top of a ‘destination’ gamut, and color coordinates are transferred from the source to the destination as closely as reasonably possible. In one embodiment, a three primary color gamut may comprise the source, and the four or more primary color gamut may comprise the destination. There are numerous gamut mapping techniques, many of these are available from the CIE technical committee of gamut mapping paper, which may be found, for example, on the world wide web at the following URL: http://www.colour.org/tc8-03/survey/survey_index.html. Various techniques are disclosed that relate to color conversion and gamut mapping. These techniques assist in the printing and displaying of images for reproduction on a printer. Such techniques or similar ones may be employed as part of the claimed subject matter to convert color-coding from a space of three colors to a space of not less than four colors.

It will, of course, be understood that although particular embodiments have been described, the claimed subject matter is not limited in scope to a particular embodiment or implementation. For example, one embodiment may be in software. Likewise, an embodiment may be in firmware, or any combination of hardware, software, and firmware. For example, a system may include a multicolor display and a computing platform coupled to the display, where the computing platform, through hardware, software or firmware or any combination thereof, is able to convert images from a three primary color space to a color space of four or more colors, for example. Likewise, although the claimed subject matter is not limited in scope in this respect, one embodiment may comprise an article, such as a storage medium. Such a storage medium, such as, for example, a CD-ROM or a disk, may have stored thereon instructions, which when executed by a system, such as, for example, a host computer or computing system or platform, or an imaging system, may result in the execution of a conversion method for converting images from a three primary color space to a color space of four or more colors.

While certain features of the claimed subject matter have been illustrated as described herein, many modifications, substitutions, changes, and equivalents will now occur to those skilled in the art. It is, therefore, to be understood that the appended claims are intended to cover all such embodiments and changes as fall within the true spirit of the claimed subject matter.

What is claimed is:

1. An apparatus comprising:
an electronic multicolor display;
said multicolor display having the capability to display an extended range of color of the color gamut of the human visible spectrum.

2. The apparatus of claim 1, wherein said display incorporates pixels capable of displaying at least four primary colors.

3. The apparatus of claim 2, wherein said pixels comprise four sub pixels wherein at least some respective sub pixels are capable of respectively displaying different primary colors.

4. The apparatus of claim 3, wherein said different primary colors comprise Red-Blue-Green-Cyan.

5. The apparatus of claim 2, wherein the materials comprising said pixels include light emitting polymers.

6. The apparatus of claim 2, wherein said pixels comprise liquid crystal material based pixels.

7. The apparatus of claim 2, wherein said display comprises a cathode-ray tube display (CRT)

8. A method comprising:
fabricating a plurality of pixels, wherein at least some of said pixels comprise at least four sub pixels.

9. The method of claim 8, wherein said at least four sub pixels respectively comprise a material capable of respectively displaying a respective one of at least four primary colors.

10. The method of claim 8, wherein said pixels are fabricated from light emitting polymers.

11. The method of claim 8, wherein said pixels are fabricated from liquid crystal material.

12. The method of claim 8, wherein said pixels are fabricated for use in a cathode ray tube display.

13. A method for displaying images, said method comprising:
converting color coding for an image from a three primary color space to a space having not less than four primary colors; and
using the converted color coding to display said image in said space having not less than four primary colors.

14. The method of claim 13, wherein said display comprises one or more pixels, wherein at least a portion of said pixels comprise at least four sub pixels.

15. The method of claim 13, wherein color converting comprises:
determining image color intensities for at least a portion of the pixels of said image in three primary color space;
multiplying at least a portion of said image color intensities with a plurality of coefficients; and
using the result of said multiplication to determine the image color intensities in four primary color space for the at least a portion of the pixels of said image.

16. The method of claim 15, wherein said coefficients are determined based at least in part on type of pixel material and type of display.

17. The method of claim 15, wherein the not less than four primary colors comprise Red-Blue-Green-Cyan.

18. The method of claim 15, wherein said display comprises a liquid crystal display (LCD).

19. The method of claim 15, wherein said display comprises a cathode-ray tube (CRT) display.

20. The method of claim 15, wherein said display comprises an electro luminescent polymer display.

21. The method of claim 15, wherein said image is coded on a computer system.

22. An article comprising:
a storage medium, said storage medium have stored thereon instructions, that, when executed, result in execution of a method for displaying images comprising:
converting color coding for an image from a three primary color space to a space having not less than four primary colors; and
using the converted color coding to display said image in said space having not less than four primary colors.

23. The article of claim 22, wherein said medium further has stored thereon instructions that, when executed, result in execution of a method for displaying images comprising:
determining image color intensities for at least a portion of the pixels of said image in three primary color space;
multiplying at least a portion of said image color intensities with a plurality of coefficients; and
using the result of said multiplication to determine the image color intensities in four primary color space for the at least a portion of the pixels of said image.

24. A system for displaying not less than four primary colors comprising:
a platform;
said platform being adapted to, in operation, convert color coding for an image from three primary color space to a space having not less than four primary colors, and being adapted to use the converted color coding to display said image in said space having not less than four primary colors.

25. The system of claim 24, and further comprising:
said computing platform being further adapted to, in operation, perform the following:
determine image color intensities for at least a portion of the pixels of said image in three primary color space;
multiply at least a portion of said image color intensities with a plurality of coefficients; and
use the result of said multiplication to determine the image color intensities in four primary color space for the at least a portion of the pixels of said image.
